(19) United States
(12) Patent Application Publication
(10) Pub. No.: US 2026/0050063 A1
(43) Pub. Date: Feb. 19, 2026

(54) SIGNAL PROCESSING DEVICE AND SIGNAL PROCESSING METHOD

(71) Applicant: NEC Corporation, Minato-ku, Tokyo (JP)

(72) Inventor: Taichi TANAKA, Tokyo (JP)

(73) Assignee: NEC Corporation, Minato-ku, Tokyo (JP)

(21) Appl. No.: 19/103,316

(22) PCT Filed: Aug. 26, 2022
(86) PCT No.: PCT/JP2022/032228

§ 371 Date: Feb. 12, 2025

(51) Int. Cl. G01S 7/292; G01S 13/90

(52) U.S. Cl. CPC G01S 7/292; G01S 13/90

(57) ABSTRACT

In the signal processing device, a cutout unit cuts out a second signal in an existence signal area that includes a reflected signal from a scatter from a first signal that represents reflection to a signal emitted from a radar, and a wraparound process unit changes a time from when the radar emits the signal to when the reflected signal is received, for the cut out second signal.

### TECHNICAL FIELD

The present invention relates to a signal processing device and a signal processing method.

### BACKGROUND ART

Synthetic aperture radar (SAR) technology is a technology which artificially synthesizes the aperture in order to obtain an image (a SAR image) equivalent to the image by an antenna having a large aperture, when a radar mounted on a flying object (an artificial satellite, an aircraft, or the like) transmits and receives a radio wave while the flying object moves. Hereinafter, a satellite (a SAR satellite) is used as an example of a flying object. A satellite is sometimes referred to as a SAR satellite.

There is a growing demand for high-resolution SAR images in which large areas are taken. In addition, research on video SAR is underway. In order to increase the resolution of SAR images, it is possible to increase the synthetic aperture length by directing the antenna toward the shooting area over a long period of time. A mode in which processing for increasing the resolution of a SAR image is executed is referred to as a high-resolution mode. In addition, when performing squint imaging (squint observation), the squint angle of the antenna is considered to be increased to expand the shooting area (see patent literature 1, for example). In squint imaging, the shooting area is taken by tilting the antenna in the azimuth direction or the opposite direction. In squint imaging, a tilt of the antenna may vary.

### CITATION LIST

### Patent Literature

PTL 1: Japanese Laid-Open Patent Publication No. 2012-093257

### SUMMARY OF INVENTION

### Technical Problem

When squint imaging is performed, a bandwidth of the signal data indicating reflection from an object widens in the range direction as the squint angle increases. As a result, an amount of data of a signal indicating reflection increases. In particular, when squint imaging is performed at high squint, an amount of signal data increases more. The increase in the size of signal data generates, the problem that a memory with a large capacity is required when the signal data is stored in the memory, for example.

The purpose of this invention is to suppress increase of an amount of data of a signal indicating reflection.

### Solution to Problem

The signal processing device according to the present invention includes cutout means for cutting out a second signal in an existence signal area that includes a reflected signal from a scatter from a first signal that represents reflection to a signal emitted from a radar, and wraparound process means for changing a time from timing of emitting the second signal to timing of receiving the reflected signal, for the cut out second signal.

The signal processing method, implemented by an information processing device, according to the present invention includes cutting out a second signal in an existence signal area that includes a reflected signal from a scatter from a first signal that represents reflection to a signal emitted from a radar, and changing a time from timing of emitting the second signal to timing of receiving the reflected signal, for the cut out second signal, by the information processing device.

The signal processing program according to the present invention causes a computer to execute a process for cutting out a second signal in an existence signal area that includes a reflected signal from a scatter from a first signal that represents reflection to a signal emitted from a radar, and a process for changing a time from timing of emitting the second signal to timing of receiving the reflected signal, for the cut out second signal.

### Advantageous Effects of Invention

According to the present invention, it is possible to suppress increase of an amount of data of a signal indicating reflection.

### BRIEF DESCRIPTION OF DRAWINGS

FIG. 1 It depicts an explanatory diagram for explaining a general method of suppressing an amount of signal data.

FIG. 2 It depicts an explanatory diagram for explaining the signal data when squint imaging is performed at high squint.

FIG. 3 It depicts a diagram for explaining the method of suppressing an amount of signal data in the example embodiments.

FIG. 4 It depicts a block diagram showing an example configuration of the signal processing device of the first example embodiment.

FIG. 5 It depicts a flowchart showing the operation of the signal processing device of the first example embodiment.

FIG. 6 It depicts a block diagram showing an example configuration of the signal processing device of the second example embodiment.

FIG. 7 It depicts a flowchart showing the operation of the signal processing device of the second example embodiment.

FIG. 8 It depicts a block diagram showing an example configuration of the signal processing device of the third example embodiment.

FIG. 9 It depicts a flowchart showing the operation of the signal processing device of the third example embodiment.

FIG. 10 It depicts a block diagram showing an example configuration of the signal processing device of the fourth example embodiment.

FIG. 11 It depicts a flowchart showing the operation of the signal processing device of the fourth example embodiment.

FIG. 12 It depicts a block diagram showing an application example including a signal processing device.

FIG. 13 It depicts a block diagram showing another application example including a signal processing device.

FIG. 14 It depicts an explanatory diagram for explaining the signal data when squint imaging is performed at high squint for a long period of time.

FIG. 15 It depicts a block diagram showing an implementation example of a signal processing device implemented in a satellite.

FIG. 16 It depicts a block diagram showing another implementation example of a signal processing device implemented in a satellite.

FIG. 17 It depicts a block diagram showing one example of a computer with a CPU.

### DESCRIPTION OF EMBODIMENTS

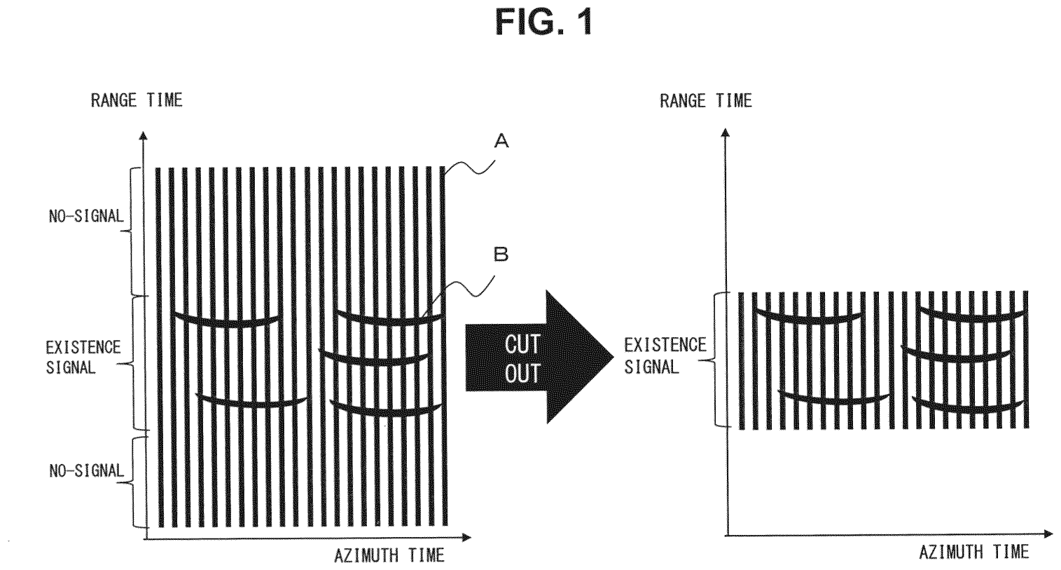

FIG. 1 is an explanatory diagram for explaining a method of suppressing an amount of signal data. The radar mounted on a satellite irradiates (or emits) pulses of electromagnetic waves (pulse signals) one after another to the observation area (shooting area). In FIG. 1, the horizontal axis represents the emitting time of each pulse (i.e., the timing at which each pulse signal is emitted). Hereinafter, the pulse firing time is referred to as azimuth time. The vertical axis represents the delay time from when the pulse is emitted until the reflected wave is received. The vertical axis can also be said to represent the elapsed time from the timing when the signal is emitted until the reflected signal, which represents the reflection to the signal, is received. Hereinafter, the time from when the pulse is emitted to when the reflected wave is received is referred to as the range time.

In FIG. 1, each of the elongated rectangle A extending in the vertical direction, i.e., in the direction of range time, represents, for example, an intensity of the reflection signal, which represents the reflection to the pulse. In the example shown in FIG. 1, only one rectangle is marked with a sign A. As shown in FIG. 1, there are numerous rectangles indicating an intensity of the reflected signal received after the pulse has been emitted once.

The rectangle does not necessarily have to represent an intensity of the reflected signal, but only a value that can identify the reflection from a reflective body from other objects. Hereinafter, the received reflected signal is denoted as “received signal” or “signal data”.

The crescent-shaped area B is a part where the reflection (backscattering) caused by point reflective bodies (scatterers) in the shooting area is recorded. Hereinafter, a point reflective body is simply referred to as a reflective body. In FIG. 1, only one of the crescent-shaped areas is marked with a sign B. FIG. 1 shows an example where there are five areas where reflections from the reflective body are recorded. Each of these areas is hereinafter represented as an area B. In FIG. 1, the area B exists across multiple rectangles A. In reality, the part where reflections from the reflective body are recorded exists only in the part overlapping rectangle A.

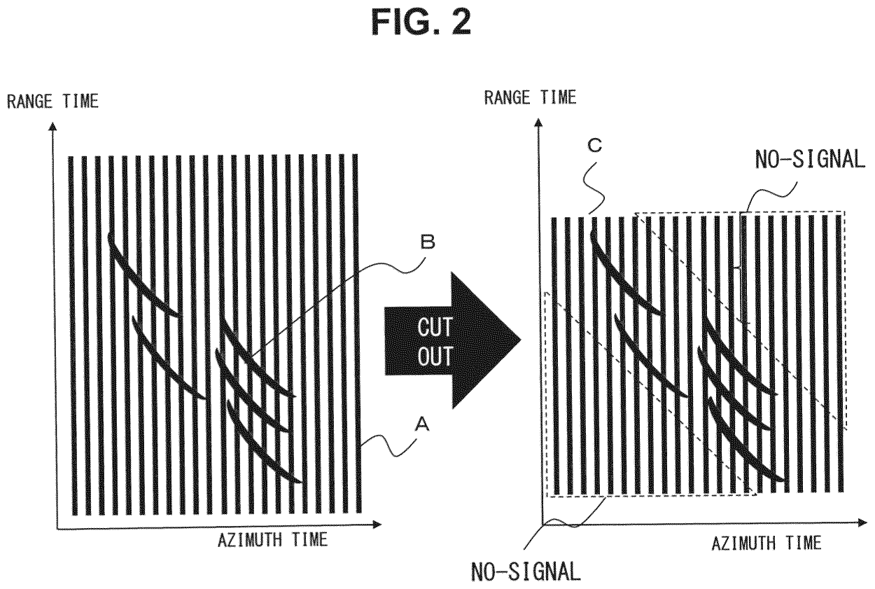

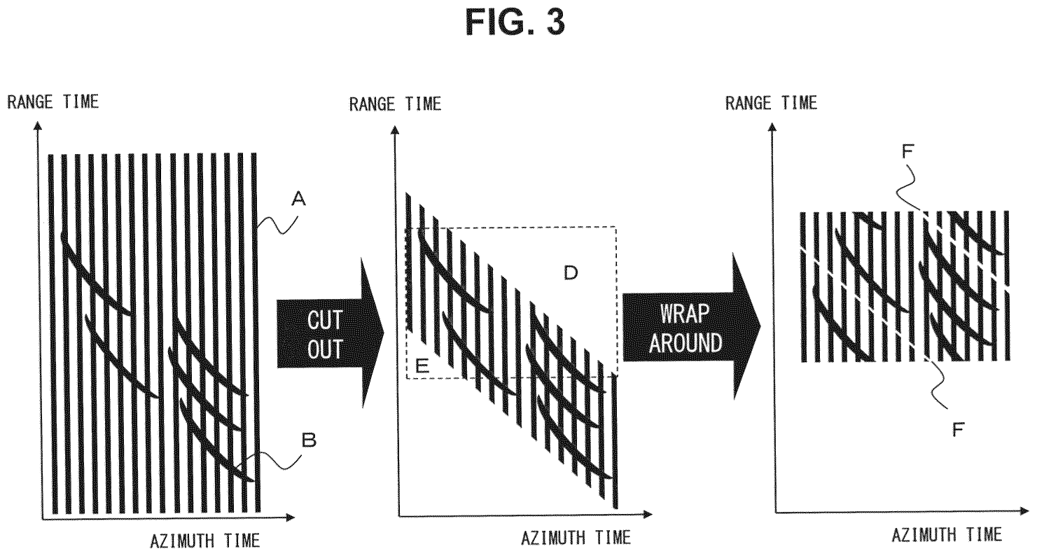

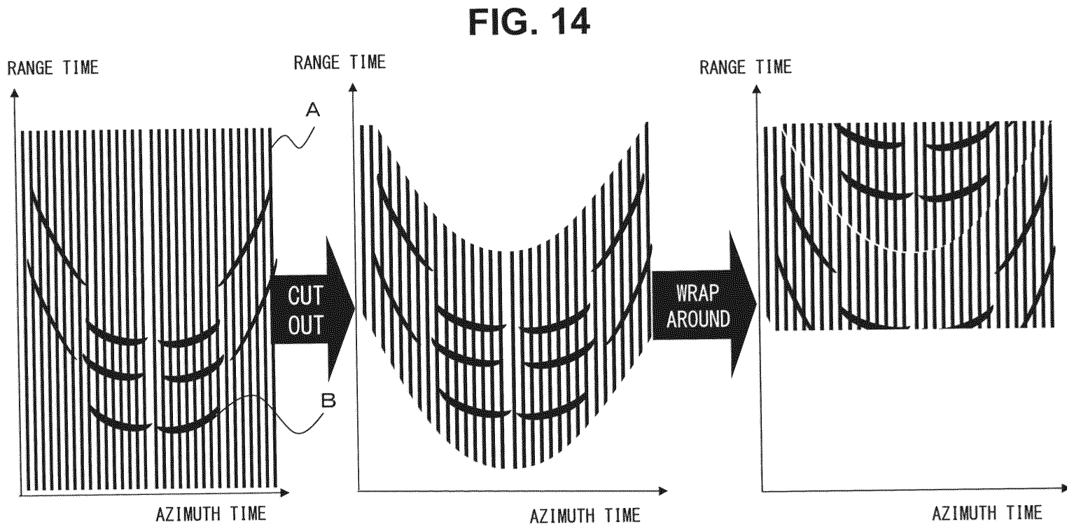

The fact that rectangle A is a signal received after a pulse is emitted once, the area B is an area where the reflection from the reflective body is recorded, and the part where the reflection from the reflective body is actually recorded only exists in the part overlapping with the rectangle A is the same in FIG. 2, FIG. 3, and FIG. 14.

As shown in FIG. 1, in the received reflection signal, there is a part where no reflection from the reflective body is observed (no-signal part, no-signal area). Such a part corresponds to area where the reflection signal from the reflective body is not recorded. It is useless to store the received signal in the no-signal part. Therefore, as shown on the right side of FIG. 1, it is conceivable to exclude the received signal in the no-signal part. Specifically, the received signal is cut out so that the range time is within a certain width based on the depth of the shooting area when measuring the reflected signal, for example. In other words, an existence signal part (or existence signal area) is cut out. Hereinafter, the existence signal area is also referred to as the “cut-out area”.

The existence signal area is an area with a certain range time width in the signal data expressed in terms of azimuth time and range time axes, as shown in FIG. 1, for example, and which includes reflections from reflective body. The existence signal area may include not only the part where the reflection from the reflective body is observed, but also the part where the reflection from the reflective body is not observed. The no-signal area does not include the part where reflections from the reflective body are observed.

FIG. 2 is an explanatory diagram for explaining the signal data when squint imaging is performed at high squint. High squint means, as an example, that the squint angle is 5° or greater. The squint angle is an angle between the direction orthogonal to the azimuth direction and the direction of electromagnetic radiation. When squint imaging at high squint is performed, especially when squint imaging at high squint is performed in high-resolution mode, the signal reflected from the shooting area is recorded in a strongly tilted form. As a result, as shown on the right side of FIG. 2, the area where the reflection is not recorded becomes large. In other words, in the case of high squint and high-resolution, by adding an effect of gazing at one spot, the time at which reflection from the reflective body begins is shifted sequentially. As a result, reflections in the obliquely tilted banded area C are recorded. The high-resolution is expressed in terms of ground resolution, for example, less than 2 meters.

When a rectangular part is set up as shown in FIG. 1 for high squint and high-resolution, a part of the no-signal area is also preserved. As a result, an amount of data including no-signal areas is large.

FIG. 3 is a diagram for explaining the method of suppressing (or reducing) an amount of signal data in the following example embodiment. FIG. 3 shows an example of the high-squint and high-resolution case. In the following example embodiment, the signal processing device cuts out the existence signal part as shown in the center in FIG. 3. In the high squint (or high-resolution) case, the existence signal part is tilted at an angle to the coordinate axes. In this case, when the area where the reflection signal is recorded is cut out with a fixed range time width, a parallelogram-shaped area is cut out as the cut-out area, as shown in the center of FIG. 3. Alternatively, the cutout area can also be said to be an area where the starting point of the range time (i.e., the range time corresponding to the bottom edge of the parallelogram shown in the middle in FIG. 3) changes as azimuth time transitions, and furthermore, the range time width is cut out to be constant. The no-signal part is the area is different from the area cut out as described above in the area shown on the left in FIG. 3.

For example, the cutout area is an area that contains all the reflected signals from the reflective body in the azimuth time direction and most of the reflected signals from the reflective body in the range time direction. By cutting out such an area, an amount of data in the existence signal part can be further reduced.

The signal processing device performs a cutout process and a wraparound process. For example, in JIS (Japanese Industrial Standards)×0013 (ISO (International Organization for Standardization)/IEC (International Electrotechnical Commission) 2382-13 “Information Processing Terminology (Graphic Processing)”), the wraparound process is defined as displaying an image part that extends beyond one edge of the display space at the opposite edge of the space.

The signal processing device sets the set area and moves the data in the cut-out area but outside the set area to a blank area within the set area. The set area is an area to be processed for the wraparound process. Alternatively, the set area can be said to be an area different from the existence signal area, and a storage area that is a destination area in which a signal in the existence signal area can be stored in wraparound processing. The set area may represent an area where the starting point of the range time is constant and the range time width is constant for each azimuth time. The set area may be a predetermined set area or an area determined to have the same time width as the range time width in the existence signal area. In the following example embodiments, the set area corresponds to the rectangular area shown on the right side of FIG. 3. The blank parts within the set area correspond to the no-signal areas D and E shown in the center in FIG. 3. The rectangle may be a rectangle or a square.

In the cutout process, the signal processing device cuts out the no-signal area and performs a wraparound process to move the existence signal part not included in the set area to the no-signal part in the set area in the range time direction. Alternatively, it can be said that the signal processing device identifies, in the cutout process, the existence signal area including a reflected signal from a reflective body from a signal area in which the received signal is represented, and performs a process of changing the elapsed time for signal data in an existence signal area that is not included in the set area. Alternatively, it can be said that the signal processing device identifies, in the cutout process, the existence signal area including a reflected signal from a reflective body from a signal area in which the received signal is represented, and performs a process of changing the elapsed time for a part of the existence signal area that does not overlap with the set area.

Alternatively, the area in which the elapsed time for a part of the existence signal area is changed as described above can be represented as a set area. In this case, it can also be said that the signal processing device identifies, in the cutout process, the existence signal area that includes the reflected signal from a reflective body from the signal area in which the received signal is represented, and generates the set area with the elapsed time changed for a part of the existence signal area.

For example, in the cutout process, the signal processing device performs a process to move the part of the parallelogram area that is above the set area to area E. It can also be said that the process is a process of moving the existence signal area at azimuth time to the no-signal area at azimuth time. In the cutout process, the signal processing device performs a process to move the part of the parallelogram area that is lower than the set area to area D.

Hereinafter, performing the wraparound process is sometimes expressed as making a received signal (reflected signal) wrap around in the range time direction.

During a set of received signals, received signals corresponding to pixel value 0 may be inserted into the signal data. An example of a received signal with a pixel value of 0 inserted diagonally is shown on the right side of FIG. 3 (see parts F in FIG. 3). The presence of the parts F in which a received signal with a pixel value of 0 is inserted makes it possible to suppress effects of side lobes, particularly side lobes at the edges of an image, when an imaging process is performed based on outputs of the signal processing device.

Hereinafter, specific example embodiments will be described with reference to the drawings.

### Example Embodiment 1

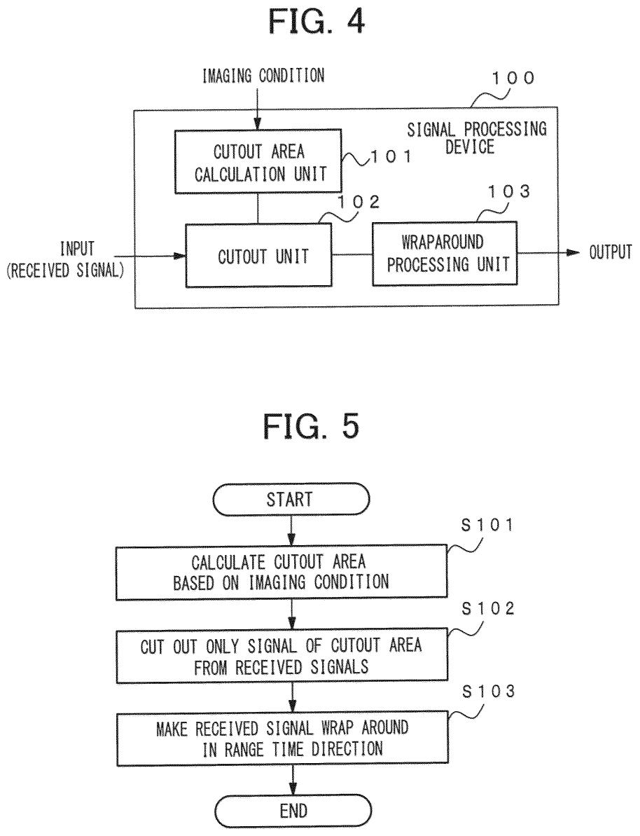

FIG. 4 is a block diagram showing an example configuration of the signal processing device of the first example embodiment. The signal processing device 100 shown in FIG. 4 comprises a cutout area calculation unit 101, a cutout unit 102, and a wraparound processing unit 103.

An imaging condition for measuring the reflected signal is input to the cutout area calculation unit 101. A signal obtained by the radar of a satellite (SAR satellite), i.e., the reflected signal, is input to the cutout unit 102. For example, the reflected signal is input to the cutout unit 102 directly from the satellite or from a storage device that stores the signals obtained by the radar of the satellite. Then, a set of received signals that have been cut out from the set of reflected signals and further processed by the wraparound process is output from the wraparound processing unit 103.

The imaging condition for measuring the reflected signal includes information for determining the size of the cutout area. The size of the cutout area is determined by a width in the direction of azimuth time and a width in the direction and range time. Alternatively, the size of the cutout area is determined by a width in the azimuth time direction, the starting point of the range time at each azimuth time, and a length of the range time. Alternatively, the size of the cutout area is determined by a width in the direction of azimuth time, the end point of the range time at each azimuth time, and a length of the range time. The imaging condition includes a squint angle, a satellite orbit, a satellite speed, an antenna rotation angle, a pulse interval, a sampling rate of a reflected wave received by the radar of the satellite, a shape of the shooting area, and antenna characteristics.

The cutout area calculation unit 101 calculates the cutout area based on the imaging condition. The cutout unit 102 cuts out the received signal in the cutout area from the received signal. The wraparound processing unit 103 performs the wraparound process on the cut-out received signal.

The above process can also be expressed as follows. The cutout unit 102 identifies the existence signal area that includes the reflected signal from a reflective body from the signal area in which the signal data is represented for the reflected signal using the elapsed time and timing from the timing when the signal is emitted from the radar to the timing when the reflected signal representing the reflection to the signal is received. The wraparound processing unit 103 performs a wraparound process in which the elapsed time for a part of the existence signal areas is changed.

Next, the operation of the signal processing device 100 is described with reference to the flowchart in FIG. 5.

The cutout area calculation unit 101 calculates a cutout area based on the imaging condition (step S101). Specifically, the cutout area calculation unit 101 calculates a time range to be cut out from a set of received signals based on the imaging condition.

The cutout unit 102 cuts out the received signals in the cutout area from the received signals (step S102). Specifically, the received signals in the cutout area are cut out from the set of received signals.

The wraparound processing unit 103 performs a wraparound process on the cutout received signals (step S103). That is, the wraparound processing unit 103 sets a rectangular area that partially overlaps the cutout area, for example. Then, the wraparound processing unit 103 moves the received signals that are included in the cutout area but not in the rectangular area to the no-signal area (see FIG. 3) within the rectangular area.

The wraparound processing unit 103 outputs a set of received signals that are cut out from the set of received signals obtained by the satellite radar and further processed with the wraparound process. The output is input to an imaging device or a storage device, for example.

The signal processing device 100 may remove the no-signal part in the cutout process. In this case, the signal processing device 100 deletes unnecessary signals. Therefore, increase of an amount of signal data is suppressed. When squint imaging at high squint is performed, the signal indicating reflection from a single object point spreads in the range direction according to the squint angle, which increases an amount of signal data. Therefore, in this example embodiment, when squint imaging at high squint is performed, the suppression of increase of an amount of signal data by the cutout process is more effective.

In addition, an amount of signal data increases when a wide area is targeted (e.g., a target area three times larger than the target area in observations by a general SAR satellite), but the signal processing device 100 of this example embodiment is also effective in such a case. In other words, when using a storage device with a predetermined capacity, the signal processing device 100 of this example embodiment can reduce an amount of signal data compared to the case of observation by a general SAR satellite, and as a result, a wider range of observation can be performed.

The signal processing device 100 also performs a wraparound process for the range time direction. An amount of reflection signal based on the reflection caused by a reflective body after the execution of the wraparound process is substantially the same as an amount of reflection signal based on the reflection caused by the reflective body before the execution of the wraparound process.

When imaging is performed by an imaging device that uses the output of the signal processing device 100, the Fourier transform in the range time direction or the Fourier transform in the range time direction and azimuth time direction may be used. The Fourier transform result in the range time direction or the Fourier transform result in the range time direction and azimuth direction based on the signal data after the wraparound process is performed will be no different from the Fourier transform result based on the signal data before the wraparound process is performed. Therefore, when an imaging algorithm that uses the Fourier transform in the range time direction or the Fourier transform in the range time direction and azimuth time direction is used, this example embodiment can be applied without changing the algorithm.

An imaging device that uses the output of the signal processing device 100 can use general imaging algorithms, as an example, the Omega K (OmegaK) algorithm or the Wavenumber Domain Algorithm. In order to ensure that an imaging device using such an imaging algorithm can perform imaging without changing the algorithm and that the area of accurate imaging is the widest, it is preferable that the signal processing device 100 has accompanying information output means that supply the imaging device with accompanying information such as the following.

For example, accompanying information includes a reference azimuth time to capture the reference point (e.g., the center of the shooting area) directly in front of the antenna, a reference range time required for electromagnetic waves to travel back and forth between the satellite and the reference point, range bin numbers corresponding to the reference range time, azimuth bin numbers corresponding to the reference azimuth time, a sampling rate of the range bin and the rate of the azimuth bin (PRF: Pulse Repetition Frequency).

Instead of supplying accompanying information such as a reference range time and a reference azimuth time to the imaging device, the accompanying information output unit may supply other types of information as described below to the imaging device.

In this example embodiment, the signal processing device 100 supplies signal data in a two-dimensional raster format to the imaging device. In other words, the signal processing device 100 supplies signal data defined by the column direction (vertical direction along the columns) and the row direction (horizontal direction along the rows) to the imaging device. For example, the column direction corresponds to the range direction. The row direction corresponds to the azimuth direction. In such a case, time information corresponding to each bin may be used as the accompanying information. A range time and an azimuth time, based on the 0th range bin and the 0th azimuth bin, may also be supplied as the accompanying information.

A circular shift may also be made in the range direction and the azimuth direction. The signal processing device 100 may include information that can identify the cutout position in the accompanying information, but the imaging device can perform the imaging process without such information.

### Example Embodiment 2

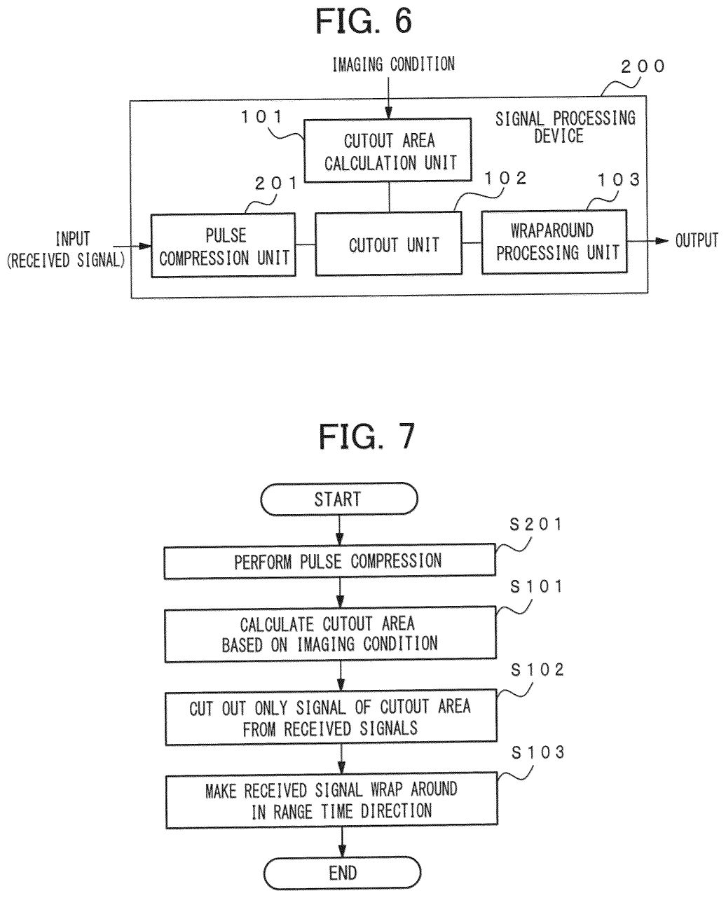

FIG. 6 is a block diagram showing an example configuration of the signal processing device of the second example embodiment. The signal processing device 200 shown in FIG. 6 comprises the cutout area calculation unit 101, the cutout unit 102, the wraparound processing unit 103, and a pulse compression unit 201. The configuration of the signal processing device 200 is the signal processing device 100 of the first example embodiment with the pulse compression unit 201 added.

The pulse compression unit 201 performs a pulse compression process. The pulse compression process is a process to narrow a pulse width of a received signal pulse by performing a predetermined cross-correlation process (a process to evaluate how much the two time-series signals are interdependent or similar) on a shape of the transmitted signal and a shape of the received signal. In the cross-correlation process, a cross-correlation function is calculated using the transmitted and received signals. When determining the cross-correlation, a method that calculates the similarity of vectors can also be used.

Next, the operation of the signal processing device 200 is explained with reference to the flowchart in FIG. 7.

The pulse compression unit 201 performs the pulse compression process described above (step S201). The pulse compression unit 201 outputs the received signal with the pulse compression process to the cutout unit 102. Other processing is the same as in the first example embodiment.

In this example embodiment, since the cutout unit 102 performs the cutout process on the received signal to which pulse compression process is applied, the cutout area can be narrower than when the cutout process is performed on the signal obtained by the satellite radar. Therefore, compared to the first example embodiment, the effect of suppressing increase of an amount of signal data is even higher.

In the field of synthetic aperture radar, an LFM (Linear Frequency Modulation) signal is often used, but in ground-based radar systems such as a body scanner, a step-like signal called a Stepped Continuous Wave is often used as a transmission signal. When the Stepped Continuous Wave is used, the pulse compression process is completed by performing an inverse Fourier transform. The concept of this example embodiment may also be applied when the Stepped Continuous Wave is used.

### Example Embodiment 3

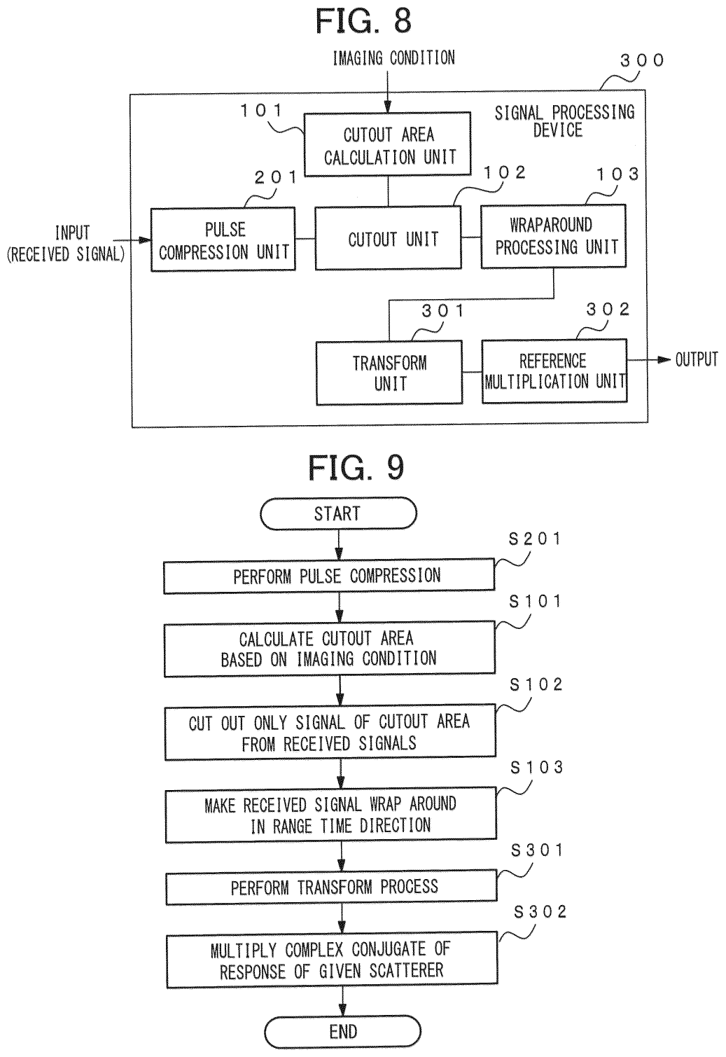

FIG. 8 is a block diagram showing an example configuration of the signal processing device of the third example embodiment. The signal processing device 300 shown in FIG. 8 comprises the cutout area calculation unit 101, the cutout unit 102, the wraparound processing unit 103, the pulse compression unit 201, a transform unit 301, and a reference multiplication unit 302. The configuration of the signal processing device 300 is the signal processing device 200 of the second example embodiment with the transform unit 301 and reference multiplication unit 302 added.

The signal processing device 300 may be configured as the signal processing device 100 of the first example embodiment with the transform unit 301 and the reference multiplication unit 302 added.

The transform unit 301 performs a transform process on the received signal output by the wraparound processing unit 103. The transform process is a process that transforms signal data to frequency domain signal data, for example. The reference multiplication unit 302 multiplies the transformed received signal by a reference signal.

Next, the operation of the signal processing device 300 is described with reference to the flowchart in FIG. 9. The processes of step S201 and steps S101-S103 are the same as in the second example embodiment.

In this example embodiment, the transform unit 301 performs a transform process on the received signal output by the wraparound processing unit 103 (step S301). In step S301, the transform unit 301 performs a Fourier transform, for example. Although the target of the Fourier transform is the received signal after the wraparound process is executed, the result of the Fourier transform is the same as the result of the Fourier transform when 0-filling is performed. Therefore, there is no need to modify the imaging algorithm when the imaging process using the Fourier transform is performed.

The reference multiplication unit 302 multiplies the Fourier transformed received signal by the reference signal as a correlation function (step S302). The reference signal is, for example, the complex conjugate of the Fourier transform of the response (ideal response) from a scatterer, assuming that the scatterer exists at the reference point (e.g., the center of the shooting area) described above. In step S302, the reference multiplication unit 302 calculates the reference signal and multiplies the Fourier transformed frequency domain received signal by the complex conjugate reference signal.

In imaging process that use the Fourier transform, the inverse Fourier transform is also performed. When the reference multiplication unit 302 is not present, since the inverse Fourier transform is performed based on the Fourier transform result of the received signal after the wraparound process is performed, the image is reproduced as if the wraparound process were performed.

When the reference multiplication unit 302 performs the above process as in this example embodiment, a clear image can be obtained around the reference point. In addition, whereas the part in which the reflection (response) caused by the scatterer was recorded was distributed in an oblique direction (see FIGS. 2 and 3), the response falls within a certain range. Therefore, when the signal processing device 300 of this example embodiment is used, the imaging process can be performed without increasing the memory capacity.

### Example Embodiment 4

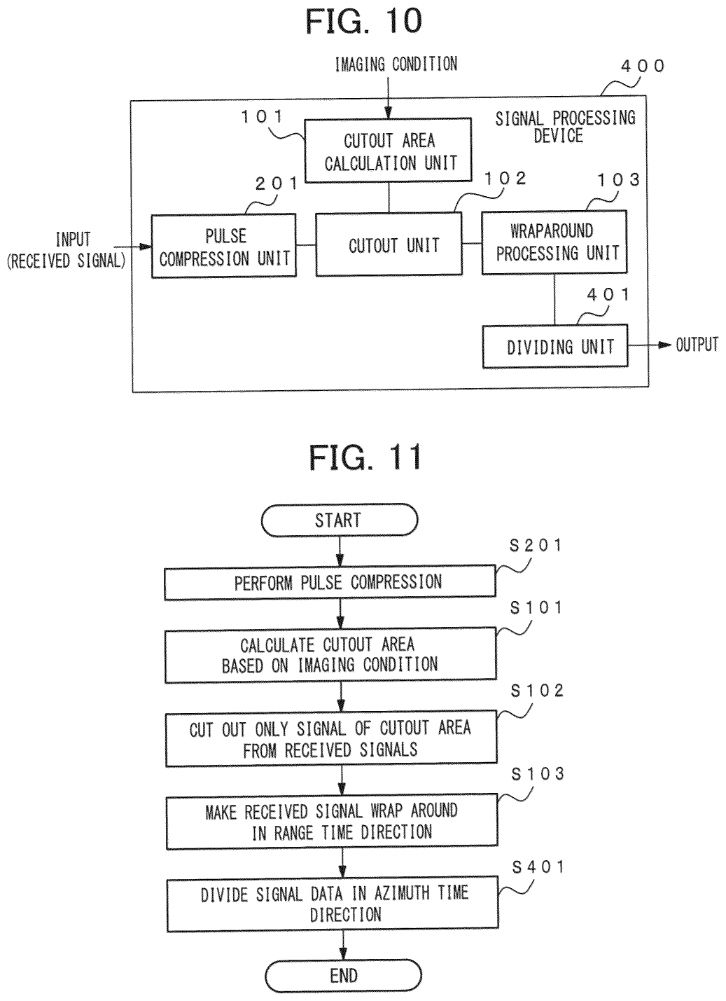

FIG. 10 is a block diagram showing an example configuration of the signal processing device of the fourth example embodiment. The signal processing device 400 shown in FIG. 10 comprises the cutout area calculation unit 101, the cutout unit 102, the wraparound processing unit 103, the pulse compression unit 201, and a dividing unit 401. The configuration of the signal processing device 400 is the signal processing device 200 of the second example embodiment with the dividing unit 401 added. The dividing unit 401 divides a set of received signals output by the wraparound processing unit 103.

The signal processing device 400 may be configured as the signal processing device 100 of the first example embodiment with a dividing unit 401 added.

Next, the operation of the signal processing device 400 is described with reference to the flowchart in FIG. 11. The processes of step S201 and steps S101-S103 are the same as in the second example embodiment.

In this example embodiment, the dividing unit 401 divides a set of received signals output by the wraparound processing unit 103 into multiple sub-blocks in the azimuth time direction (step S401). The dividing unit 401 may divide the set so that two adjacent sub-blocks do not overlap, but may also divide the set so that two adjacent sub-blocks have an overlapping portion.

In this example embodiment, since the signal processing device 400 outputs multiple sub-blocks, an imaging device can easily reproduce a high-resolution image using multiple sub-blocks. In addition, the processing load on the imaging device that reproduces a video using the output of the signal processing device 400 is reduced.

Between the wraparound processing unit 103 and the dividing unit 401, there may be the transform unit that performs the Fourier transform, etc. and the reference multiplication unit in the third example embodiment and an inverse transform unit that performs the inverse Fourier transform, etc.

Hereinafter, application examples of the above example embodiments will be explained.

The output of the signal processing devices of the above example embodiments can be used, for example, as an input to an imaging device that performs a combination of the Omega K algorithm that is one of the imaging algorithms and a process on a two-dimensional spectrum, and Baseband Azimuth Scaling that is is one of high-resolution processing methods.

In addition, the following methods can be used as imaging algorithms in the imaging device, for example.
Wavenumber Domain Algorithm (Stolt may be applied) which is a process on a two-dimensional spectrum other than the Omega K algorithm.
Range Doppler algorithm which is a process in the range time domain and the azimuth frequency domain
Chirp scaling algorithm which is a process in the range and azimuth-frequency domains, but with some transformations in the range-frequency domain
Back Projection which is a process in the range and azimuth time domains

A variant of the above algorithm can also be used as an imaging algorithm.

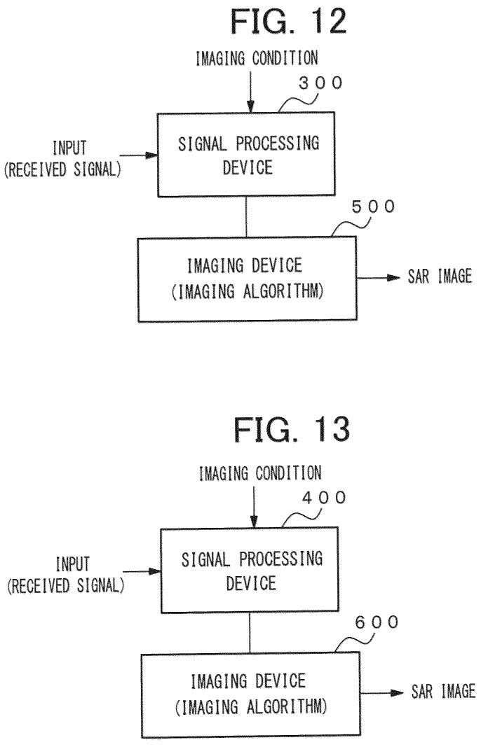

FIG. 12 is a block diagram showing an application example including the signal processing device 300 of the third example embodiment. The output of the signal processing device 300 is supplied to an imaging device 500 that performs an imaging process based on a predetermined imaging algorithm.

### Application Example 1

The imaging algorithm is assumed to be the Omega K algorithm. The Omega K algorithm includes a two-dimensional Fourier transform process, a reference multiplication process, a deformation process that performs spectral deformation, and an inverse two-dimensional Fourier transform process.

The two-dimensional Fourier transform process and reference multiplication process in the Omega K algorithm can be performed by the transform unit 301 and reference multiplication unit 302 in the signal processing device 300. Therefore, in application example 1, the imaging device 500 only needs to perform the deformation process and inverse two-dimensional Fourier transform process.

When the signal processing device 100 of the first example embodiment or the signal processing device 200 of the second example embodiment is combined with the imaging device 500, the imaging device 500 performs the two-dimensional Fourier transform process, the reference multiplication process, the deformation process, and the inverse two-dimensional Fourier transform process.

When an imaging process based on the Omega K algorithm which performs processing in the frequency domain, is performed as an imaging process using the output of the signal processing device of the above example embodiment, there is no need to modify the Omega K algorithm. For example, a image based on squint imaging at high squint, for example, can be reproduced without modifying the existing program that executes the Omega K algorithm and without increasing the capacity of the memory that stores the data.

### Application Example 2

The imaging algorithm is assumed to be the range Doppler algorithm. The range Doppler algorithm includes a two-dimensional Fourier transform process, a reference multiplication process, an inverse Fourier transform process in the range direction, a deformation process (RCMC: Range Cell Migration Correction), an imaging multiplication process, and an inverse Fourier transform process in the azimuth direction.

The two-dimensional Fourier transform process and the reference multiplication process in the range Doppler algorithm can be performed by the transform unit 301 and reference multiplication unit 302 in the signal processing device 300. Therefore, in the application example 2, the imaging device 500 only needs to perform the inverse Fourier transform process in the range direction, the deformation process, the imaging multiplication process, and the inverse Fourier transform process in the azimuth direction.

When the signal processing device 100 of the first example embodiment or the signal processing device 200 of the second example embodiment is combined with the imaging device 500, the imaging device 500 performs the two-dimensional Fourier transform process, the reference multiplication process, the inverse Fourier transform process in the range direction, the deformation process, the imaging multiplication process, and the inverse Fourier transform process in the azimuth direction.

When an imaging process based on the range Doppler algorithm which performs processing in the time domain, is performed as an imaging process using the output of the signal processing devices of the above example embodiments, there is no need to modify the range Doppler algorithm. For example, an image based on squint imaging at high squint, for example, can be reproduced without modifying the existing program that executes the range Doppler algorithm and without increasing the capacity of the memory that stores the data.

### Application Example 3

The imaging algorithm is assumed to be the chirp scaling algorithm. The chirp scaling algorithm includes a two-dimensional Fourier transform process, a reference multiplication process, an inverse Fourier transform process in the range direction, a chirp process to multiply the chirp signal, a Fourier transform process in the range direction, a second chirp process, an inverse Fourier transform process in the range direction, an imaging multiplication process, and an inverse Fourier transform process in the azimuth direction.

The two-dimensional Fourier transform process and the reference multiplication process in the chirp scaling algorithm can be performed by the transform unit 301 and reference multiplication unit 302 in the signal processing device 300. Therefore, in the application example 3, the imaging device 500 only needs to perform the inverse Fourier transform process in the range direction, the chirp process to multiply the chirp signal, the Fourier transform process in the range direction, the second chirp process, the inverse Fourier transform process in the range direction, the imaging multiplication process, and the inverse Fourier transform process in the azimuth direction.

When the signal processing device 100 of the first example embodiment or the signal processing device 200 of the second example embodiment is combined with the imaging device 500, the imaging device 500 performs the two-dimensional Fourier transform process, the reference multiplication process, the inverse Fourier transform process in the range direction, the chirp process to multiply the chirp signal, the Fourier transform process in the range direction, the second chirp processing, the inverse Fourier transform process in the range direction, the imaging multiplication process, and the inverse Fourier transform process in the azimuth direction.

When an imaging process based on the chirp scaling algorithm that performs processing in the time domain is performed as an imaging process using the output of the signal processing devices of the above example embodiments, there is no need to modify the chirp scaling algorithm. For example, an image based on squint imaging at high squint, for example, can be reproduced without modifying the program that executes the existing chirp scaling algorithm and without increasing the capacity of the memory that stores the data.

FIG. 13 is a block diagram showing an application example including the signal processing device 400 of the fourth example embodiment. The output of the signal processing device 400 is supplied to an imaging device 600 that performs an imaging process based on a predetermined imaging algorithm.

### Application Example 4

The imaging algorithm is assumed to be the Baseband Azimuth Scaling algorithm. The Baseband Azimuth Scaling algorithm includes a dividing process, a process that includes the same chirp scaling process (including at least a two-dimensional Fourier transform process and a reference multiplication process) described above for each of the sub-blocks, and a process to combine sub-blocks after processing, etc.

The dividing process in the Baseband Azimuth Scaling algorithm can be performed by the dividing unit 401 in the signal processing device 400. As mentioned above, when the signal processing device 400 also includes a transform unit and a reference multiplication unit, the dividing process, the two-dimensional Fourier transform process, and the reference multiplication process can be performed by the dividing unit 401, the transform unit, and the reference multiplication unit in the signal processing device 400. Therefore, in the application example 4, the imaging device 600 only needs to perform a process performed after the dividing process in the Baseband Azimuth Scaling algorithm, or after a process perform the dividing process, two-dimensional Fourier transform process, and the reference multiplication process. When an imaging process (in this example, then imaging process based on the Baseband Azimuth Scaling algorithm) is performed using the output of the signal processing devices of the above example embodiments, there is no need to modify the Baseband Azimuth Scaling algorithm. For example, an image based on squint imaging in high squint, for example, can be reproduced without modifying the existing program that executes the Baseband Azimuth Scaling algorithm and without increasing the capacity of the memory that stores the data.

### Application Example 5

FIG. 14 is an explanatory diagram for explaining the signal data when squint imaging is performed at high squint for a long period of time. When squint imaging at high squint of the target area is performed over a long period of time, the orientation of the antenna on the satellite is controlled so that the antenna always faces the target area and the squint angle changes as the satellite moves. As a result, as shown on the left side of FIG. 14, for example, the part (crescent-shaped area B) in the shooting area where the reflection caused by the scattering is recorded has multiple types of tilts. In the example shown in FIG. 14, there are two areas B, one toward the lower right and the other toward the upper right.

In such a case, instead of setting a parallelogram-shaped cutout area (see the center part in FIG. 3), the cutout unit 102 in the above example embodiments should set a cutout area with a curved part that matches the slope of area B. Then, the wraparound processing unit 103 can perform the wraparound process in the same way as in the above example embodiments.

The cutout area with a curved part that matches the tilte of area B is the area that contains the reflection signals of all reflective bodies in the azimuth time direction and the most reflective bodies in the range time direction.

In other words, even when squint imaging is performed at high squint for long periods of time, the effect of increasing an amount of signal data is maintained simply by changing the shape of the cut-out area from a parallelogram.

The signal processing device can generate a video with a play time corresponding to the observation time of the target area. In reality, the play time of a video is determined by the capacity of a storage device for storing SAR images.

The signal processing devices of the above example embodiments may be installed on the ground, or it may be mounted on a satellite.

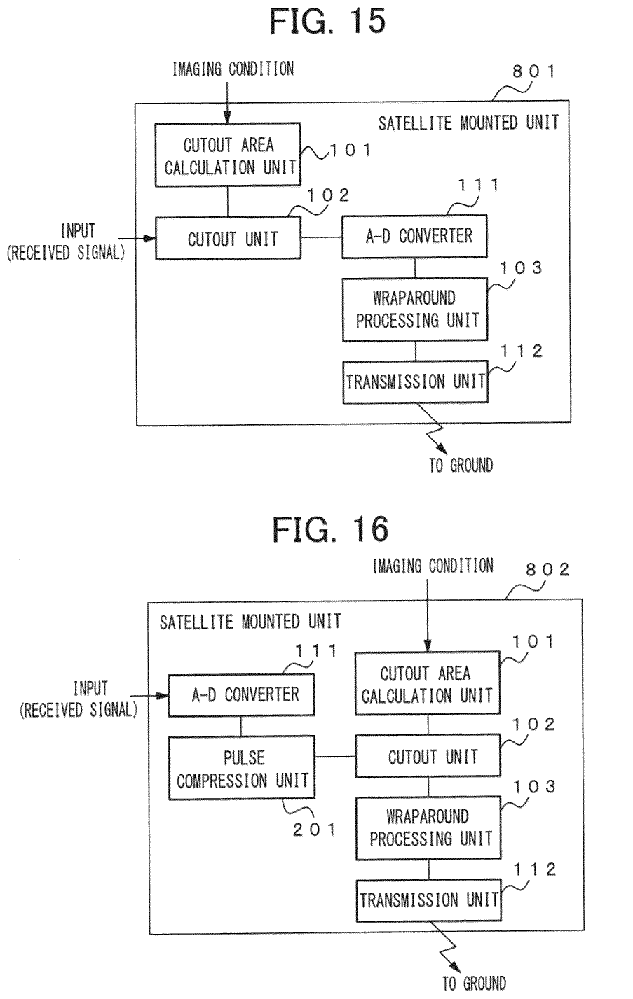

FIG. 15 is a block diagram showing an example of a signal processing device implemented in a satellite. In the example shown in FIG. 15, the signal processing device 100 of the first example embodiment shown in FIG. 4 is implemented in a satellite. That is, the satellite mounted unit 801 includes the components of the signal processing device 100.

The satellite mounted unit 801 further includes an A-D converter 111 for A-D conversion of the received signal in the cutout area and a transmission unit 112 for transmitting the received signal after the wraparound process to the ground. The transmission unit 112 includes a wireless communication unit for wireless communication. In addition to the wireless communication unit, the transmission unit 112 may include an encoding unit to encode the received signal after the wraparound process.

When the satellite includes means to perform the cutout process by hardware, that means may be used as the cutout unit 102. In such a case, the cutout area calculation unit 101 and the wraparound processing unit 103 are realized by software, for example.

FIG. 16 is a block diagram showing another example of a signal processing device implemented in a satellite. In the example shown in FIG. 16, the signal processing device 200 of the second example embodiment shown in FIG. 6 is implemented in a satellite. That is, the satellite mounted unit 802 includes the components of the signal processing device 200.

The satellite mounted unit 802 further includes the A-D converter 111 for A-D conversion of the received signal and the transmission unit 112 for transmitting the received signal to the ground after the wraparound process.

When the satellite has a function to perform pulse compression, that function may be used as the pulse compression unit 201. In that case, the cutout area calculation unit 101, the cutout unit 102, and the wraparound processing unit 103 are realized by software, for example.

According to the configurations shown in FIG. 15 and FIG. 16, an amount of data transmitted from a flying object such as a satellite to the ground is reduced compared to a general configuration without the signal processing device of the above example embodiments.

When the signal processing device of the above example embodiments is installed on the ground, for example, when the signal processing device of the above example embodiments is incorporated in the imaging device on the ground, the storage capacity in the device on the ground is saved.

The signal processing devices of the above example embodiment can be applied to synthetic aperture technologies other than synthetic aperture radar technology that uses flying objects, such as a synthetic aperture sonar. The signal processing devices of the above example embodiments can also be applied to ISAR (Inverse Synthetic Aperture Radar).

Each component in each of the above example embodiments may be configured with a piece of hardware or a piece of software. Alternatively, the components may be configured with a plurality of pieces of hardware or a plurality of pieces of software. Further, part of the components may be configured with hardware and the other part with software.

For example, in the configurations shown in FIG. 15 and FIG. 16, the functions of the cutout unit 102 and the pulse compression unit 201 can be realized by hardware, while the other functions can be configured by software.

Each function (each process) in the above example embodiments may be realized by a computer having a processor such as a CPU (central processing unit), a memory, etc. For example, a program for performing the method in the above example embodiments may be stored in a storage device, and the functions may be realized with the CPU executing the program stored in the storage device.

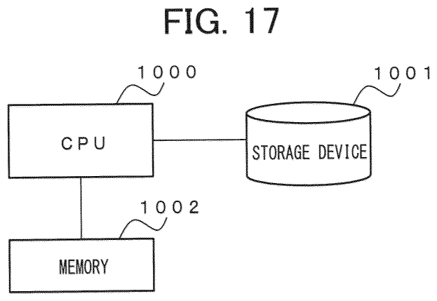

FIG. 17 is a block diagram showing one example of a computer with a CPU. The computer is implemented in a signal processing device. The CPU 1000 executes processing according to a signal processing program stored in a storage device 1001 to realize the functions of the cutout area calculation unit 101, the cutout unit 102, the wraparound processing unit 103, the pulse compression unit 201, the pulse compression unit 201, the transform unit 301, the reference multiplication unit 302, and the dividing unit 401 in the above example embodiments.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disc), a CD-ROM (Compact Disc-Read Only Memory), a CD-R (Compact Disc-Recordable), a CD-R/W (Compact Disc-ReWritable), and a semiconductor memory (for example, a mask ROM, a PROM (programmable ROM), an EPROM (erasable PROM), a flash ROM).

The program may be stored in various types of transitory computer readable media. The transitory computer readable medium is supplied with the program through, for example, a wired or wireless communication channel, i.e., through electric signals, optical signals, or electromagnetic waves.

A memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

100, 200, 300, 400 Signal processing device
101 Cutout area calculation unit
102 Cutout unit
103 Wraparound processing unit
201 Pulse compression unit
301 Transform unit
302 Reference multiplication unit
401 Dividing unit
500, 600 Imaging device
801, 802 Satellite mounted unit
1000 CPU
1001 Storage device
1002 Memory

What is claimed is:

1. A signal processing device, comprising:
a memory storing software instructions, and
one or more processors configured to execute the software instructions to
cut out a second signal in an existence signal area that includes a reflected signal from a scatter from a first signal that represents reflection to a signal emitted from a radar, and
change a time from when the radar emits the signal to when the reflected signal is received, for the cut out second signal.

2. The signal processing device according to claim 1, wherein
the one or more processors are configured to execute the software instructions to
cut out the second signal from an area where the first signal is represented according to timing at which the radar emits the signal and elapsed time until the first signal is received, and
move the second signal which does not overlap with a storage area, in the existence signal area, that is a destination area in which the second signal can be stored.

3. The signal processing device according to claim 1, wherein
the one or more processors are configured to further execute the software instructions to identify the existence signal area based on an imaging condition when measuring the reflected signal.

4. The signal processing device according to claim 3, wherein
the existence signal area is defined in the azimuth time direction and range time direction, and
the one or more processors are configured to execute the software instructions to
the area calculation means determines the existence signal area with a boundary that tilts in the azimuth time direction.

5. The signal processing device according to claim 1, wherein
the one or more processors are configured to further execute the software instructions to output accompanying information including at least an azimuth time for a reference point in a shooting area, a range time, a range bin number corresponding to the range time, and an azimuth bin number corresponding to the azimuth time.

6. The signal processing device according to claim 1, wherein
the one or more processors are configured to further execute the software instructions to output accompanying information including a range bin number and an azimuth bin number for a reference point in the shooting area based on a 0th range bin and a 0th azimuth bin.

7. The signal processing device according to claim 1, wherein
the one or more processors are configured to further execute the software instructions to perform a pulse compression process on the signal and the reflected signal, and wherein
the one or more processors are configured to execute the software instructions to cut out the second signal using a signal with the pulse compression process applied.

8. The signal processing device according to claim 1, wherein
the one or more processors are configured to further execute the software instructions to
transform an output of the wraparound process means into frequency domain data, and
multiply transformed data by a reference signal as a correlation function.

9. A signal processing method, implemented by an information processing device, comprising:
cutting out a second signal in an existence signal area that includes a reflected signal from a scatter from a first signal that represents reflection to a signal emitted from a radar, and
changing a time from when the radar emits the signal to when the reflected signal is received.

10. A non-transitory computer readable storage medium for storing a program for causing a computer to execute:
a process for cutting out a second signal in an existence signal area that includes a reflected signal from a scatter from a first signal that represents reflection to a signal emitted from a radar, and
a process for changing a time from when the radar emits the signal to when the reflected signal is received, for the cut out second signal.

11. The signal processing device according to claim 2, wherein
the one or more processors are configured to further execute the software instructions to identify the existence signal area based on an imaging condition when measuring the reflected signal.

12. The signal processing method according to claim 9, further comprising
cutting out the second signal from an area where the first signal is represented according to timing at which the radar emits the signal and elapsed time until the first signal is received, and
moving the second signal which does not overlap with a storage area, in the existence signal area, that is a destination area in which the second signal can be stored.
